(19) United States
(12) Patent Application Publication
(10) Pub. No.: US 2026/0248293 A1
(43) Pub. Date: Aug. 27, 2026

(54) VIBRATION APPARATUS OF ELECTRIC BED

(71) Applicant: STAR SEEDS CO., LTD., Lukang Township (TW)

(72) Inventors: Chuan-Hang SHIH, Lukang Township (TW); Yu-Chi YANG, Lukang Township (TW); Wen-Chi HSU, Lukang Township (TW)

(73) Assignee: STAR SEEDS CO., LTD., Lukang Township (TW)

(21) Appl. No.: 19/064,258

(22) Filed: Feb. 26, 2025

(51) Int. Cl. A47C 21/00; A47C 19/02; A61H 1/00

(52) U.S. Cl. CPC A47C 21/006; A47C 19/025; A61H 1/005; A61H 2201/0142

(57) ABSTRACT

A vibration apparatus of an electric bed includes a bed board having a hollow portion, and a base mount having a main body disposed with the bed board, a through hole communicated with the hollow portion, and at least three suspension arms extending from the main body to the through hole. Each suspension arm has a first end connected with the main body and a second end located in the through hole. At least three supporting members each have a base portion disposed with the main body or the first end of one suspension arm, and an extension portion abutting the second end of another suspension arm. A vibrator is located in the hollow portion and connected with the second ends of the suspension arms. The vibration apparatus of the electric bed is not only structurally stable and durable but also capable of delivering an appropriate vibration force.

### BACKGROUND OF THE INVENTION

### 1. Field of the Invention

The present invention relates generally to an electric bed and more particularly, to a vibration apparatus of an electric bed .

### 2. Description of the Related Art

Conventional electric beds, which feature the ability to electrically adjust the angle of the bed board, have been increasingly favored by consumers. To enhance user experience, some electric beds are equipped with vibration apparatuses, such as vibrating motors or subwoofers. Since these vibration apparatuses continuously generate vibrations during operation, the challenge for the industry has been to ensure that users can feel the vibrations without experiencing discomfort. If the connection structure between the vibration apparatus and the electric bed is too rigid, it may cause discomfort to the user; conversely, if the connection structure is too flexible, it may excessively weaken the vibration force and the connection structure is prone to damage. Therefore, conventional electric beds with vibration apparatuses still have room for improvement.

### SUMMARY OF THE INVENTION

The present invention has been accomplished in view of the above-noted circumstances. It is an objective of the present invention to provide a vibration apparatus of an electric bed, which has a stable and durable structure and is capable of delivering an appropriate level of vibration force.

To attain the above objective, the present invention provides a vibration apparatus of an electric bed comprises a bed board, a base mount, at least three supporting members, and a vibrator. The bed board has a hollow portion. The base mount includes a main body disposed with the bed board, a through hole formed in the main body and communicated with the hollow portion, and at least three suspension arms extending from the main body into the through hole. Each suspension arm has a first end connected with the main body, and a second end opposite to the first end and located in the through hole. Each supporting member has a base portion disposed with the main body of the base mount or the first end of one of the suspension arms, and an extension portion extending from the base portion and abutting the second end of another suspension arm. The vibrator is located in the hollow portion and connected with the second ends of the suspension arms. With the aforementioned structural features, the vibration apparatus of the electric bed is not only structurally stable and durable but also capable of delivering an appropriate level of vibration force.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a vibration apparatus of an electric bed according to a preferred embodiment of the present invention;

FIG. 2 is a sectional view of a part of the vibration apparatus of the electric bed according to the preferred embodiment of the present invention;

FIG. 3 is an exploded view of the vibration apparatus of the electric bed according to the preferred embodiment of the present invention; and

FIG. 4 is a perspective view of a base mount of the vibration apparatus of the electric bed according to the preferred embodiment of the present invention.

### DETAILED DESCRIPTION OF THE INVENTION

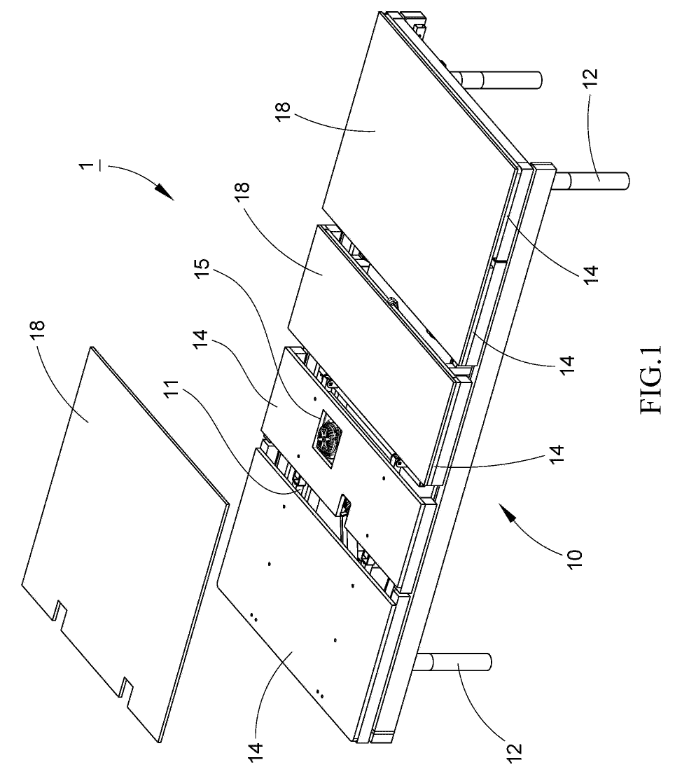

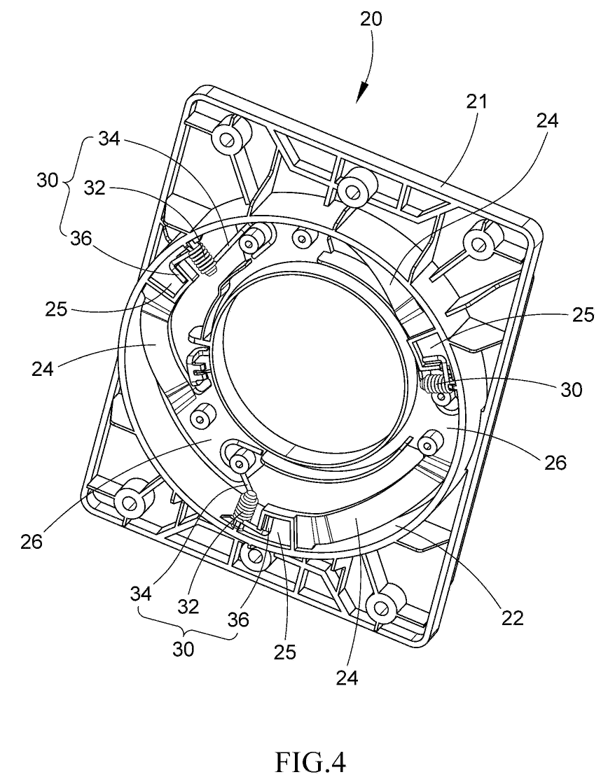

The structure and technical features of the present invention will be detailedly described hereunder by an embodiment and accompany drawings. As shown in FIGS. 1-4, a vibration apparatus 1 of an electric bed provided by a preferred embodiment of the present invention comprises a bedstead 10, five bed boards 14 disposed on a top side of the bedstead 10, three cushion pads 18 arranged on the five bed boards 14, a base mount 20, at least three supporting members 30, and a vibrator 40.

The bedstead 10 includes a skeleton 11 and four supporting legs 12 disposed below the skeleton 11 to support the skeleton 11 at a predetermined height above the ground, facilitating user access to and leave from the electric bed. However, the supporting legs 12 may be omitted.

Each of the five bed boards 14 may accommodate the base mount 20. In this embodiment, the second bed board 14 counting from the left side of FIG. 1 is used as an example for illustration. The bed board 14 includes a rectangular hollow portion 15. The bed board 14 may be made of wood, metal, or other materials, and may have a solid plate structure or a mesh structure.

To enhance comfort, the cushion pads 18 are provided on the bed boards 14. These cushion pads 18 may be made of foam materials such as polyurethane foam, silicone, rubber, cotton padding, or other materials with cushioning properties.

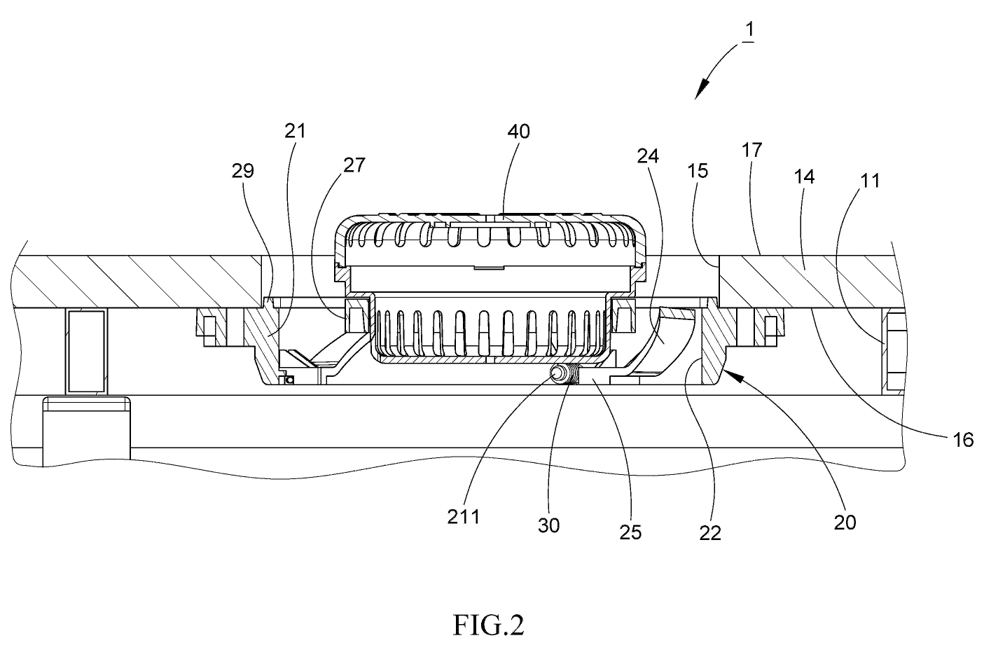

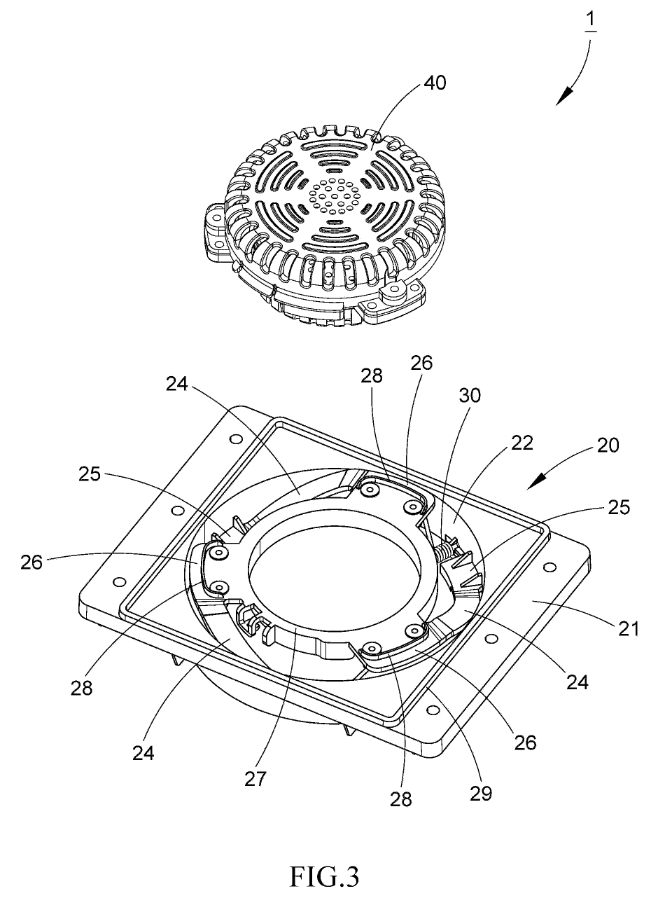

The base mount 20 includes a rectangular main body 21 disposed on a bottom side 16 of the bed board 14, a circular through hole 22 formed in the main body 21 and communicated with the hollow portion 15, three suspension arms 24 extending from the main body 21 into the through hole 22, and a circular inner ring 27 connected with the suspension arms 24. The main body 21 further includes three posts 211 extending into the through hole 22 in a way that the posts 211 are positioned between the suspension arms 24. Each suspension arm 24 extends along an inner wall of the through hole 22 and has a first end 25 connected with the main body 21, and a second end 26 opposite to the first end 25 and located inside the through hole 22. As viewed from the angles in FIGS. 2 and 3, the second end 26 is positioned higher than the first end 25.

Each supporting member 30 includes a base portion 32 disposed with the main body 21 of the base mount 20, an extension portion 34 extending obliquely upward from the base portion 32, and an abutting portion 36 extending from the base portion 32 in an opposite direction. In this embodiment, the supporting member 30 is a torsion spring. The base portion 32 is tubular and sleeved onto the post 211 of the main body 21. The extension portion 34 is abutted against the second end 26 of the adjacent suspension arm 24 to support the second end 26 of the associated suspension arm 24, while the abutting portion 36 is positioned against the first end 25 of the adjacent suspension arm 24 to enhance the securing effect. Through this configuration, the supporting members 30 assist in supporting the second ends 26 of the suspension arms 24. However, the shape of the supporting member 30 is not limited to this specific form.

The vibrator 40 is positioned within the hollow portion 15 and connected to the second ends 26 of the suspension arms 24 via bolts (not shown). The vibrator 40 may be a vibration motor with a cam, a subwoofer, or any other device capable of generating vibrations. The bottom portion 42 of the vibrator 40 has a short cylindrical shape and is inserted into the inner ring 27 of the base mount 20. In other words, the inner ring 27 is sleeved onto the vibrator 40 to assist in securing the vibrator 40 to the base mount 20 in a way that the vibrator 40 protrudes over the top surface 17 of the bed board 14.

To further secure the positioning of the vibrator 40, limiting portions 28 may be provided at the second ends 26 of the suspension arms 24, surrounding around the outer periphery of the vibrator 40. These limiting portions 28 ensure that the vibrator 40 remains positioned within them, thereby stably connecting the vibrator 40 to the base mount 20.

To further secure the positioning of the base mount 20, a flange 29 corresponding in shape to the hollow portion 15 may also be provided on the main body 21. The flange 29 may be configured extending into the hollow portion 15 and being abutted against an inner edge of the hollow portion 15.

The vibrations generated by the vibrator 40 can be transmitted upward to the cushion pad 18 or a mattress (not shown) placed on the cushion pad 18, allowing the user to feel the vibrations. Additionally, these vibrations are attenuated when transmitted to the bed board 14 due to the buffering effect of the suspension arms 24. This not only reduces discomfort to the user but also provides adequate support for the vibrator 40, delivering an optimal level of vibration force. Furthermore, the supporting members 30 help reinforce the suspension arms 24, preventing the suspension arms 24 from breaking upon experiencing the vibrations of the vibrator 40 for a long time. This enhances the structural stability and achieves the objectives of the present invention.

Based on the technical features of the present invention, various modifications to the vibration apparatus 1 of the electric bed may be made. For example, the number of suspension arms 24 may be increased as needed; the main body 21 of the base mount 20 may be positioned on the top surface 17 of the bed board 14 or within the hollow portion 15; the vibrator 40 may be flush with the top surface 17 of the bed board 14; the posts 211 may be omitted; the supporting members 30 may be disposed to other locations on the main body 21 or at the first ends 25 of the suspension arms 24; the supporting members 30 may be elastic pieces or other elastic structures; and the abutting portion 36 of the supporting member 30 may be omitted. Such variations are not to be regarded as a departure from the scope of the invention, and all such modifications as would be obvious to one skilled in the art are intended to be included within the scope of the following claims.

What is claimed is:

1. A vibration apparatus of an electric bed, comprising:
a bed board having a hollow portion;
a base mount including a main body disposed with the bed board, a through
hole formed in the main body and communicated with the hollow portion, and at least three suspension arms extending from the main body into the through hole, wherein each of the suspension arms has a first end connected with the main body, and a second end opposite to the first end and located in the througₕ hole;at least three supporting members, each of which includes a base portion
disposed with the main body of the base mount or the first end of one of the suspension arms, and an extension portion extending from the base portion and abutting against the second end of another one of the suspension arms; anda vibrator located in the hollow portion and connected with the second ends of the suspension arms.

2. The vibration apparatus of the electric bed as claimed in claim 1, wherein the main body of the base mount is disposed at a bottom side of the bed board.

3. The vibration apparatus of the electric bed as claimed in claim 1, wherein the
suspension arms extend along an inner wall of the through hole.

4. The vibration apparatus of the electric bed as claimed in claim 3, wherein the second end of each of the suspension arms is positioned higₕer than the first end of each of the suspension arms.

5. The vibration apparatus of the electric bed as claimed in claim 1, wherein the second end of each of the suspension arms is positioned higher than the first end of each of the suspension arms.

6. The vibration apparatus of the electric bed as claimed in claim 1, wherein the base mount further comprises an inner ring connected with the second ends of the suspension arms and sleeved onto the vibrator.

7. The vibration apparatus of the electric bed as claimed in claim 1, wherein the
second end of each of the suspension arms is provided with a limiting portion located around an outer periphery of the vibrator.

8. The vibration apparatus of the electric bed as claimed in claim 1, wherein the vibrator protrudes over or is flush with a top surface of the bed board.

9. The vibration apparatus of the electric bed as claimed in claim 1, wherein main body of the base mount includes at least three posts extending into the through hole in a way that the posts are located between the suspension arms for being disposed with the base portions of the supporting members, respectively.

10. The vibration apparatus of the electric bed as claimed in claim 9, wherein each of the supporting members includes an abutting portion extending from the base portion and abutting against the first end of one of the suspension arms.

11. The vibration apparatus of the electric bed as claimed in claim 9, wherein
the supporting members are torsion springs.

12. The vibration apparatus of the electric bed as claimed in claim 1, wherein the supporting members are torsion springs.
